(19) United States
(12) Patent Application Publication
(10) Pub. No.: US 2011/0101263 A1
(43) Pub. Date: May 5, 2011

(54) SOLVENT-DISPERSIBLE PARTICLE, FABRICATION METHOD THEREOF, AND DISPERSION

(75) Inventors: Shuzo Tokumitsu, Shinjuku-ku (JP); Yuki Hirajima, Shinjuku-ku (JP)

(73) Assignee: HOYA CORPORATION, Shinjuku-ku (JP)

(21) Appl. No.: 12/913,892

(22) Filed: Oct. 28, 2010

(30) Foreign Application Priority Data
Oct. 30, 2009 (JP) 2009-251232
Oct. 30, 2009 (JP) 2009-251233

(51) Int. Cl. H01F 1/06; B05D 5/00

(52) U.S. Cl. 252/62.55; 423/326

(57) ABSTRACT

A multi-component alloy particle containing at least two metal components and at least one surface modifier contacting the metal components where in the multi-component alloy particle atoms of the metal components are arranged in an ordered manner, and the multi-component alloy particle is ferromagnetic and disperses in a solvent. Method for making the multi-component alloy particle.

### CROSS REFERENCES TO RELATED APPLICATIONS

This application claims priority under 35 U.S.C. §119 to Japanese Patent Application Nos. 2009-251232, filed Oct. 30, 2009, and 2009-251233, filed Oct. 30, 2009, the entire contents of both applications being incorporated herein by reference.

### BACKGROUND OF THE INVENTION

1. Field of the Invention

The present invention relates to a solvent-dispersible particle, a fabrication method thereof, and a dispersion. More specifically, the present invention relates to ferromagnetic ordered alloy nanoparticles having excellent dispersibility in a polar solvent such as water, which are expected to be applicable in the biochemistry or medical fields, a fabrication method thereof, and a dispersion obtained by dispersing these particles in a polar solvent.

2. Description of the Related Art

Crystal structure of an alloy particle, such as FePt, possesses a phase in which the atom arrangement thereof is disordered and a phase in which the atom arrangement thereof is ordered. Since the alloy particle with an ordered structure has relatively high magnetic anisotropy and its magnetic characteristics are not quenched even if the particle diameter is less than or equal to 10 nm, the application to high-density magnetic recording medium with the use of particles with such a characteristic has been considered (hereinafter, particles with such a characteristic is referred to as “ordered alloy nanoparticles”).

Moreover, the application of the magnetic characteristic of such alloy particles in fields such as biochemistry, medicine, diagnostic agent (magnetic beads) and the like has been expected in recent years. In order to apply such magnetic characteristic in these fields, it is necessary that the ordered alloy nanoparticles be uniformly dispersed in a polar solvent, particularly, in water. When this condition is satisfied, the ordered alloy nanoparticles and the dispersion thereof possess biocompatibility.

When the alloy nanocrystalline particles, such as FePt, are produced by a liquid phase synthesis, the crystal structure of the particles generally is a disordered structure (fcc phase), and the magnetic anisotropy of the particle is relatively low (superparamagnetism). However, by being subjected to a heat treatment, the structure is transited to an ordered structure (fct phase) in which Fe and Pt are alternately laminated. As a result, the ordered alloy nanoparticles have high magnetic anisotropy (ferromagnetism).

Since this heat treatment generally needs to be performed at a temperature of greater than or equal to 500° C., there is a problem where fusion between particles occurs, which results in an increase in particle size. As one of the solutions to this problem, a method is known in which the heat treatment is performed while the particles are covered with metal oxide, such as SiO₂. According to this method, the crystal structure of each particle can be transited to an ordered structure while preventing fusion between the particles even when the heat treatment is performed at a temperature of greater than or equal to 500° C. However, since fusion between the coats of the particles occurs, the coats need to be removed in order to disperse the particles in the solvent. The particles from which the coats have been removed have strong spontaneous magnetization, which results in magnetic aggregation of the particles. Since it is difficult to prevent this aggregation even with ultrasonication, it is extremely difficult to uniformly disperse the particles in the solvent by the same method as that for particles with a disordered structure.

In order to solve this problem, a method for preventing the aggregation of the particles, in which cationic surfactant is combined with the surface of the particle while the shell of the core-shell particle after the heat treatment is dissolved in an aqueous sodium hydroxide solution, is suggested in Patent Document 1. This is a method which is performed in a system separated into two phases including a phase of an alkali solution (aqueous sodium hydroxide solution) and a phase of an organic solvent (chloroform) and in which the metal oxide coat is dissolved in the phase of the alkali solution, and the cationic surfactant is then combined with the bare surface of the particle, from which the coat has peeled off, in the phase of the organic solvent. Thus, the phase of the organic solvent contains the ordered alloy nanoparticles with the cationic surfactant combined with their surfaces.

### RELATED ART DOCUMENT

Patent Document 1 WO2006/070572

### SUMMARY OF THE INVENTION

### Problem that the Invention is to Solve

However, the ordered alloy nanoparticles obtained by the above-mentioned method have a structure in which hydrophobic groups of the cationic surfactant are oriented so as to face the side of the solvent. Therefore, while the ordered alloy nanoparticles have dispersibility in the organic solvent which separates from the alkali solution and is a non-polar or extremely low polar solvent, the ordered alloy nanoparticles do not have dispersibility in a high polar solvent, such as water.

In addition, according to the above-mentioned method, the dissolution of the coats and bonding of the cationic surfactant are respectively performed in different phases. However, since the bare particles (the ordered alloy nanoparticles with no modifiers, such as a surfactant, attached to the surfaces) more easily come close to each other if the coats of the particles peel off in the phase of the alkali solution, stronger magnetic attraction is generated, and the aggregation of the particles immediately occurs before moving on to the phase of the organic solvent.

The object of the present invention is to provide a solvent-dispersible particle which has high dispersibility in a high polar solvent, such as water, while having ferromagnetism, a method by which such particles can be effectively fabricated, and a dispersion which is obtained by dispersing such particles in a polar solvent.

### Means for Solving the Problem

Such an object can be achieved by the present invention of the following (1) to (13).

(1) A solvent-dispersible particle in which a multi-component alloy particle including two or more kinds of metal components is combined with at least one surface modifier, wherein in the multi-component alloy particle, atoms of the metal components are arranged in an ordered manner, and the multi-component alloy particle has ferromagnetism, wherein the surface modifier includes, within its one molecule, one or more functional groups X interacting with one kind from among the two or more kinds of metal components, one or more functional groups Y interacting with the other kind, and one or more functional groups Z having affinity for a polar solvent.

Thus, it is possible to obtain the solvent-dispersible particle which has high dispersibility in the polar solvent while having ferromagnetism.

(2) The solvent-dispersible particle according to above (1), wherein the multi-component alloy particle is an alloy particle including, as the metal components, a group of elements A of at least one kind selected from transitional metal elements belonging to the 4^{th} period of a long format periodic table, except for Cu, and a group of elements B of at least one kind selected from transitional metal elements belonging to the platinum group and the 11^{th} group of the long format periodic table.

Such an alloy particle can keep ferromagnetism because of its ordered crystal structure even if the particle diameter is decreased to the nm order.

(3) The solvent-dispersible particle according to above (2), wherein the group of elements A includes Fe or Co, and the group of elements B includes Pt or Pd.

Since the particle has high magnetic anisotropy in a direction of an axis of easy magnetization when the particle has an ordered structure in which the group of elements A and the group of elements B are alternately laminated, the particle can possess high coercivity even with a particle diameter of less than or equal to 10 nm.

(4) The solvent-dispersible particle according to above (2), wherein the functional group X is a functional group interacting with the group of elements A, and the functional group Y is a functional group interacting with the group of elements B.

Thus, the surface modifiers are firmly fixed to the surface of the multi-component alloy particle via bonding at two positions. As a result, it is possible to further prevent the surface modifiers from detaching from the multi-component alloy particle. That is, if one of the two bondings detaches, the surface modifier is fixed via one still remaining bonding. Therefore, the probability that the surface modifiers detach is decreased.

In addition, if two functional groups (the functional group X and the functional group Y) from among the functional groups within one molecule interact with the surface of the multi-component alloy particle, the remaining functional group Z is oriented so as to face the side of the solvent of the multi-component alloy particle necessarily with higher probability. As a result, the surface is reliably covered with the functional group Z, and it is possible to obtain the solvent-dispersible particle with higher dispersibility.

(5) The solvent-dispersible particle according to (1), wherein the interaction of the functional group X with respect to the group of elements A and the interaction of the functional group Y with respect to the group of elements B are one of a covalent bonding, an ionic bonding, and a coordinate bonding, respectively.

Since these bondings have higher bonding strength as compared with the electrostatic interaction which is an adsorption principle of the surfactant or the like and the interaction such as intermolecular force or the like, it is possible to keep the combining state between the multi-component alloy particle and the surface modifiers for a long time. That is, it is difficult for surface modifiers to detach due to external factors, and the dispersibility of the solvent-dispersible particle is enhanced.

(6) The solvent-dispersible particle according to (1), wherein the functional group X is a functional group which can become a hard base, and the functional group Y is a functional group which can become a soft base.

Thus, the functional group X generates a stable and selective interaction with one kind of metal component in the multi-component alloy particle, and the functional group Y generates a stable and selective interaction with another kind of metal component. As a result, the surface modifiers can be combined in an ordered manner with high density so as to cover the surface of the multi-component alloy particle.

(7) The solvent-dispersible particle according to (1), wherein the functional group Z is a functional group having a polarity.

Since the functional group Z is positioned on the side of the solvent, the particles have excellent dispersibility in the polar solvent by using the functional group as described above as the functional group Z.

(8) The solvent-dispersible particle according to (1), wherein in one molecule of the surface modifier, the number of carbon atoms between the functional group X and the functional group Y is from 1 to 4.

Thus, the relationship between the distance from the functional group X to the functional group Y and the distance from an atom of element a to an atom of element b in the multi-component alloy particle is optimized, and the surface modifiers attain a structure in which both the functional group X and the functional group Y can interact with the surface of the multi-component alloy particle with an ordered structure.

(9) The solvent-dispersible particle according to (1), wherein the molecule of the surface modifier includes a carboxyl group on at least one of its ends.

Since the carboxyl group can be included in a functional group X or functional group Y and a functional group Z, an optimal orientation state can be obtained for the surface modifiers regardless of whether the carboxyl group faces the side of the particles or faces the side of the solvent.

That is, by positioning the carboxyl group at the end of the molecular chain, it is possible to reliably arrange the functional group Z on the side of the solvent.

(10) The solvent-dispersible particle according to (1), wherein the average diameter of the multi-component alloy particle is 1 to 30 nm.

Thus, sufficient magnetic characteristics are secured while the mass of each multi-component alloy particle is suppressed to be sufficiently small. Therefore, the multi-component alloy particle can exhibit excellent magnetic characteristics for various applications and can keep dispersing for a long time in the dispersion.

(11) The solvent-dispersible particle according to (1), wherein the coercivity of the multi-component alloy particle is greater than or equal to 1 kOe.

Thus, even when the multi-component alloy particle with high coercivity as described above is contained, it is possible to obtain the solvent-dispersible particle with a satisfactory dispersibility in the polar solvent.

(12) A fabrication method of the solvent-dispersible particle according to (1), including: a first step of forming a temporarily coat so as to cover the multi-component alloy particle to obtain a covered particle; a second step of causing the crystal structure of the multi-component alloy particle to be ordered by a heat treatment and thereby to cause the multi-component alloy particle to have ferromagnetism; and a third step of removing the temporarily coat in a liquid phase, exposing the surface of the multi-component alloy particle, and causing the surface modifiers to combine with the surface of the surface, wherein in the third step, removal of the temporarily coat and bonding of the surface modifiers are simultaneously performed in the same liquid phase.

Thus, it is possible to effectively fabricate the solvent-dispersible particle using a simple method while causing the solvent-dispersible particle to have ferromagnetism.

(13) A dispersion which is obtained by dispersing the solvent-dispersible particle according to (1) in a polar solvent.

Thus, it is possible to obtain the dispersion which has a biocompatibility while containing the solvent-dispersible particle having ferromagnetism and which can be applied in the field of biochemistry and the medical field.

(14) The dispersion according to above (13), wherein the polar solvent is water.

Thus, even if the dispersion is administered in blood, for example, the dispersion has an affinity for blood without separating therefrom. Accordingly, it is possible to obtain the solvent-dispersible particle which can behave in the same manner as blood in the body and minimize adverse effects on the living body.

### ADVANTAGE OF THE INVENTION

According to the present invention, since it is possible to introduce the surface modifiers to the multi-component alloy particle with high density, it is possible to provide a ferromagnetic ordered alloy nanocrystalline particle (solvent-dispersible particle) which has excellent dispersibility in a high polar solvent, such as water, while causing the multi-component alloy particle to have ferromagnetism without aggregation, and to provide a fabrication method thereof.

In addition, according to the present invention, it is possible to provide a dispersion which has biocompatibility and can be applied to biochemistry and the medical field by dispersing the above solvent-dispersible particle in the solvent with high polarity.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram schematically illustrating the bonding state between a multi-component alloy particle and surface modifiers according to a solvent dispersible particle of the present invention.

FIG. 2 is a diagram schematically illustrating the state in which a covered particle is made to be in contact with a reaction solution retained in a container.

FIG. 3 shows XRD patterns of a covered particle before a heat treatment, a covered particle after the heat treatment, and a solvent-dispersible particle of the present invention.

FIG. 4 shows TEM observation images of the covered particle after the heat treatment and the solvent-dispersible particle of the present invention.

FIG. 5 shows H-M curves of the covered particle after the heat treatment and the solvent-dispersible particle of the present invention.

### BEST MODE FOR CARRYING OUT THE INVENTION

Hereinafter, a detailed description will be made of the solvent-dispersible particle, the fabrication method thereof, and the dispersion according to the present invention based on the preferred embodiment shown in the accompanying drawings.

The solvent-dispersible particle of the present invention includes a multi-component alloy particle in which the crystal structure of the particle is an ordered structure (a particle including two or more kinds of metal components) and surface modifiers which cover the surface of this particle.

Since the surface of such a solvent-dispersible particle is covered with the surface modifiers with high density while the multi-component alloy particle has ferromagnetism, the aggregation of the particles can be prevented even when the solvent-dispersible particle are dispersed in a polar solvent, such as water. For this reason, it is possible to provide a dispersion which can be applied to biochemistry and the medical field, with the use of the characteristic that the solvent-dispersible particle of the present invention is a ferromagnetic particle which can be dispersed in a polar solvent.

Hereinafter, the configurations of the solvent-dispersible particle and the dispersion will be sequentially described.

### Multi-Component Alloy Particle

The multi-component alloy particle in the solvent-dispersible particle of the present invention is not particularly limited as long as it is a particle with a composition in which two or more kinds of metal components are included and the crystal structure is an ordered structure. However, examples of such a particle include an alloy particle containing a group of elements A of at least one kind selected from transitional metal elements belonging to the 4^{th} period of a long format periodic table, except for Cu and a group of elements B of at least one kind selected from transitional metal elements belonging to the platinum group and the 11^{th} group of the long format periodic table. Since the crystal structure of the particle is an ordered structure, such an alloy particle can keep ferromagnetism even if the particle diameter is decreased to the nano meter order.

The specific examples of the elements belonging to the group of elements A include Sc, Ti, V, Cr, Mn, Fe, Co, and Ni. One of these elements or two or more of these elements constitute the group of elements A. In addition, it is preferable that at least one element selected from Fe, Co, and Ni is included, and it is more preferable that at least one element selected from Fe and Co is included from among the above elements. Since any of these elements alone have ferromagnetism, they are useful in consideration of the magnetic characteristic of the multi-component alloy particle.

On the other hand, the specific examples of the elements belonging to the group of elements B include Ru, Rh, Pd, Os, Ir, and Pt as the elements belonging to the platinum group, and Cu, Ag, and Au as the transitional metal elements belonging to the 11^{th} group of the long format periodic table. One of these elements or two or more of these elements constitute the group of elements B. In addition, it is preferable that at least one element selected from Ru, Rh, Pd, Os, Ir and Pt is included, and it is more preferable that at least one element selected from Pd and Pt is included from among the above elements.

Since the particle, such an FePd alloy, an FePt alloy, a CoPd alloy, a CoPt alloy, or the like, has high magnetic anisotropy in the direction of the axis of easy magnetization when the crystal structure of the particle is an ordered structure, such a particle can possess high coercivity of several kOe even when the particle diameter is less than or equal to 10 nm. Accordingly, such a particle is preferable for a high-density magnetic recording medium and a magnetoresistive element, of course, and is also preferable for a magnetic alloy particle used in biochemistry and the medical field.

Here, when the alloy particle containing the group of elements A and the group of elements B is synthesized by an ordinary liquid phase synthesis method, the crystal structure of the alloy particle is a face-centered cubic structure (fcc structure). In this structure, the elements belonging to the group of elements A and the elements belonging to the group of elements B are arranged in a disordered manner, and the magnetic anisotropy is relatively low. However, when such a multi-component alloy particle is subjected to a heat treatment, the atom arrangement is ordered, and the crystal structure is transited to the ordered L1₀ type face-centered tetragonal structure (fct structure) in which the layer of the elements belonging to the group of elements A and the layer of the elements belonging to the group of elements B are alternately laminated. Such ordered structure has high magnetic anisotropy in the direction of the axis of easy magnetization, and this magnetic anisotropy is not impaired even if the particle diameter is decreased to be less than or equal to 10 nm. For this reason, with the multi-component alloy particle as described above, it is possible to obtain a nano meter order diameter of magnetic alloy particle having high coercivity.

In addition, the multi-component alloy particle used in the present invention is not limited to the particle formed by the heat treatment, and a particle fabricated by any other method is applicable as long as it has an ordered structure and has ferromagnetism.

The average particle diameter of such a multi-component alloy particle is preferably about 1 to 30 nm from the viewpoint of dispersibility to the solvent. A more preferable particle diameter differs depending on the purpose, about 5 to 10 nm of the particle diameter is preferable for use in the magnetic recording medium, and about 10 to 20 nm of the particle diameter is preferable for use in biochemistry or the medical field while it may change depending on the purpose of usage. When the particle diameter of the multi-component alloy particle is in the above range, the mass of each particle is suppressed to be sufficiently small while sufficient magnetic characteristics are secured. Therefore, the excellent magnetic characteristics of the particle are exhibited, and the particles can keep dispersing in solvent for a long time for various applications.

When the particle diameter of the multi-component alloy particle is below the lower limit, the magnetic characteristic of each particle becomes insufficient since the particle diameter is excessively small. On the other hand, when the particle diameter of the multi-component alloy particle is over the upper limit, precipitation easily occurs in the dispersion, and there is a concern that it becomes difficult to fabricate the solvent-dispersible particle with a uniform dispersibility.

The coercivity of the multi-component alloy particle is preferably greater than or equal to 3 kOe (2.39×10⁵ A/m) and more preferably greater than or equal to 5 kOe (3.98×10⁵ A/m) when the multi-component alloy particle is used in a magnetic recording medium. On the other hand, the coercivity is preferably greater than or equal to 1 kOe (7.96×10⁴ A/m) when the multi-component alloy particle is used in biochemistry or the medical field. The multi-component alloy particle with such coercivity exhibits superior magnetic characteristics for the applications as described above, and the solvent-dispersible particle becomes more useful. That is, according to the present invention, it is possible to obtain the solvent-dispersible particle which has a satisfactory dispersibility in the polar solvent even with the multi-component alloy particle has high coercivity as described above.

### Surface Modifiers

The surface modifiers in the solvent-dispersible particle of the present invention are combined so as to cover the surface of the above-mentioned multi-component alloy particle. The surface modifier includes, within its one molecule, one or more functional groups X interacting with one kind from among the two or more kinds of metal components in the multi-component alloy particle, one or more functional groups Y interacting with the other kind, and one or more functional groups Z having affinity for a polar solvent.

Here, examples of the above interaction include actions of being combined with or adsorbed to the surface of the multi-component alloy particle, such as a covalent bonding, an ionic bonding, a coordinate bonding, and the like. Since these bonding types have higher bonding strength as compared with the electrostatic interaction which is an adsorption principle of the surfactant or the like and the interaction such as intermolecular force or the like, it is possible to keep the bonding between the multi-component alloy particle and the surface modifiers for a long time. That is, it is difficult for the surface modifiers to detach due to external factors, and the dispersibility of the particle in solvent is improved.

Further, a polar solvent is a liquid including polar molecules having high relative permittivity (molecules having permanent dipoles). Polar solvents can be illustrated by examples, such as water, methanol, acetic acid, and acetone.

Hereinafter, a description will be made of the functional group X, the functional group Y, and the functional group Z. In addition, a description will be made here while exemplifying, as an example of the multi-component alloy particle, a two-component alloy particle containing an element a belonging to the group of elements A and an element b belonging to the group of elements B as the metal components. In addition, it is assumed that X represents a functional group interacting with the element a and Y represents a functional group interacting with the element b. Moreover, the functional group Z also has a function, in some cases, of combining with a specific substance, such as protein or the like, and furthermore, the same kind of functional group as the functional group X or the functional group Y becomes the functional group Z in some cases.

By introducing the surface modifiers with such functional groups to the surface of the multi-component alloy particle, the functional group X combines with the element a, and the functional group Y combines with the element b. In addition, since the functional group Z having affinity for the polar solvent exists as a residual group, the multi-component alloy particle to which the surface modifiers have been introduced, that is, the solvent-dispersible particle can be satisfactorily dispersed in the polar solvent.

As a functional group X, a functional group which can be a hard base can be exemplified, and specifically, the following can be considered: a primary amino group, a secondary amino group, a carboxyl group and its deprotonated form, a hydroxy group and its deprotonated form, an ether group, a phosphine oxide group, further, a phosphonate group, a phosphinate group, a phosphate group, a sulfonate group, a β-diketone group, or the like. In addition, the hard base is a base which is categorized based on the HSAB rule (hard and soft acids and bases rule), is relatively difficultly polarized, has a large electronegativity, and can form a stable compound with a hard acid. On the other hand, according to the HSAB rule, a metal ion can be regarded as an acid, and the hardness and the softness thereof correspond to the ionization potential of the metal. Therefore, the functional group X generates a stable and selective interaction with the element a belonging to the group of elements A, which has a larger ionization potential and corresponds to the hard acids, from among the group of elements A and the group of elements B.

On the other hand, as a functional group Y, a functional group which can be a soft base can be exemplified, and specifically, the following can be considered: an aromatic amino group, a pyridyl group, an amide group, a mercapto group and its deprotonated form, a sulfide group, a phosphine group, a phosphite ester group, a thiophene group, an ethene group, an alkyl group, a cyano group, a thiocyano group, sulfoxide group, and a sulfonic group, or the like. In addition, the soft base is a base which is categorized based on the HSAB rule, is relatively easily polarized, has a small electronegativity, and can form a stable compound with a soft acid. Therefore, the functional group Y generates a stable and selective interaction with the element b belonging to the group of elements B, which has a smaller ionization potential and corresponds to the soft acids, from among the group of elements A and the group of elements B.

In addition, the hard base and the soft base are relatively categorized as described above, and the same functional group may be categorized as a hard base in some cases and may be categorized as a soft base in other cases depending on the combination of the functional groups.

As the functional group Z, a functional group having affinity for the polar solvent, that is, a functional group with a polarity can be exemplified, and the specific examples include —COO⁻, —NH₃⁺, —SO₃⁻, —PO₃²⁻, —R₃N⁺, —O⁻, —O—, an ethylene glycol group, and the like. Such a functional group Z has a high affinity especially for the polar solvent, and provides the solvent-dispersible particle with a satisfactory dispersibility in the polar solvent.

In addition, each functional group as described above combines with one molecular chain and constitutes a surface modifier. This molecular chain may be formed in any one of a linear shape, a branched shape, a circular shape, and the like.

Here, the functional group X interacts with the element a, and the functional group Y interacts with the element b. Thus, the surface modifiers are firmly fixed to the surface of the multi-component alloy particle via bondings at two positions. As a result, it is possible to reliably prevent the surface modifiers from detaching from the multi-component alloy particle. That is, if one of the two bondings detaches, the surface modifier is fixed via one still remaining bonding. Therefore, the probability that the surface modifiers detach is decreased.

If two functional groups (the functional group X and the functional group Y) from among the functional groups in one molecule interact with the surface of the multi-component alloy particle, the remaining functional group Z is inevitably oriented so as to face the side of the solvent with high probability. As a result, the surface is reliably covered with the functional group Z, and the solvent-dispersible particle with higher dispersibility can be obtained.

Here, the multi-component alloy particle with an ordered structure has a structure in which the layer of the elements a and the layer of the elements b are alternately laminated as described above. Therefore, it is considered that a structure in which the elements a and the elements b are alternately arranged can be easily made on the surface of the particle. For this reason, the element a and the element b are adjacent or close to each other with high probability, and the functional group X and the functional group Y of one molecule combine with the element a and the element b with high probability.

In other words, when the crystal structure of the multi-component alloy particle is a disordered structure (fcc structure), the element a and the element b are not always adjacent or close to each other on the surface of the particle. Therefore, even if the functional group X interacts with the element a, there is a possibility of the functional group Y not reaching the element b since the element b is separated from the element a. In such a case, there is a concern that the surface modifiers detach since the bonding is made at one position, and the surface modifiers are insufficiently fixed.

On the other hand, when the multi-component alloy particle has an ordered structure (fct structure), the bondings between the surface modifiers and the surface of the multi-component alloy particle are formed at two positions with high probability as described above. Therefore, the surface modifiers are more firmly fixed to the surface of the multi-component alloy particle.

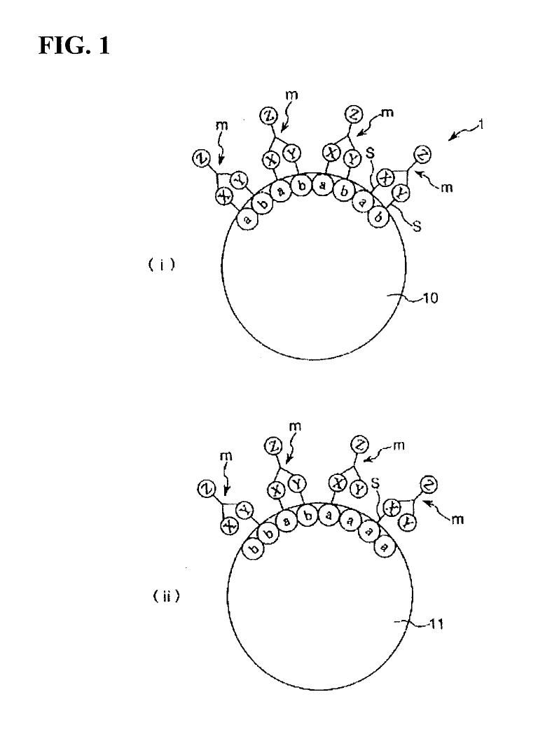

Here, a diagram schematically illustrating the bonding state between the multi-component alloy particle and the surface modifiers according to the solvent-dispersible particle of the present invention will be shown in FIG. 1.

FIG. 1 shows an arrangement example of four surface modifiers m, and atoms of the element a and the atoms of the element b, with which the surface modifiers combine, in a solvent-dispersible particle 1. FIG. 1 (ii) shows an example in which the surface modifiers m are introduced to the surface of a multi-component alloy particle 11 with a disordered structure. As shown in this example, the surface modifiers m combining via one bonding s are formed. In such a case, the surface modifiers m are insufficiently fixed.

On the other hand, FIG. 1(i) shows an example in which the surface modifiers m are introduced to the surface of the multi-component alloy particle 10 with an ordered structure. As shown in this example, if the element a and the element b are arranged in an ordered manner, the surface modifiers m are also arranged in an ordered manner in accordance with the arrangement of the element a and the element b. Therefore, the functional group X inevitably comes close to the atoms of the element a, the functional group Y inevitably comes close to the atoms of the element b, and the bondings s are formed at two positions with high probability. As a result, the surface modifiers m combine with no gap and with high density so as to cover the surface of the multi-component alloy particle 10 with an ordered structure, and the functional group Z is arranged on the surface of the solvent-dispersible particle 1 with no gap and with high density. Since such a solvent-dispersible particle 1 exhibits satisfactory dispersibility especially in the polar solvent, and the distance between the particles can be maintained, aggregation can be prevented.

In addition, from the viewpoint of the bonding property between the surface modifiers and the multi-component alloy particle, the present inventors have discovered an optimal range for the number of carbon atoms between the functional group X and the functional group Y. The number of carbon atoms is preferably from 1 to 4, more preferably from 1 to 3, and further preferably from 1 to 2. If the number of carbon atoms between the functional group X and the functional group Y is in this range, the relationship between the distance from the functional group X to the functional group Y and the distance from the atom of element a and the atom of the element b in the multi-component alloy particle is optimized, and a structure of the surface modifiers can be obtained in which both the functional group X and the functional group Y can interact with respect to the surface of the multi-component alloy particle with an ordered structure.

In addition, when the number of carbon atoms exceeds the upper limit, the functional group X and the functional group Y are excessively apart from each other, and the plurality of surface modifiers acts as steric barriers and the surface modifiers easily interfere with each other. Therefore, there is a concern that the formation of the bonding is prevented and the introduction density of the surface modifiers is decreased. For example, there is a case in which the functional group Y and the functional group Z are the same kind of functional group depending on the kind of the functional group. Since the functional group Y cannot be specified in such a case, the number of countable carbon atoms becomes two in some cases. In that case, the smaller number is applicable as the number of carbon atoms. In the above description, the number of carbon atoms is defined with the assumption that the main chain (molecular chain) of the surface modifiers is a carbon chain. However, when atoms (for example, sulfur atoms) other than carbon atoms are contained in the main chain between the functional group X and the functional group Y, it is preferable that the number of the atoms, which includes the number of atoms other than carbon atoms, is in the same range as the above range for the number of carbon atoms.

As described above, the functional group Z is the same kind as the functional group X and the functional group Y in some cases, and the examples of such a functional group include a carboxyl group. It is preferable that the carboxyl group is positioned at least at one end of the molecular chain (surface modifiers). As described above, since the carboxyl group can be the functional group X or the functional group Y and the functional group Z, an optimal orientation state can be obtained for the surface modifiers regardless of whether the carboxyl group faces the side of the particle or the side of the solvent. That is, by positioning the carboxyl group at the end of the molecular chain, the functional group Z can be reliably arranged on the side of the solvent.

Such a surface modifier having the functional group X, the functional group Y, and the functional group Z, is not particularly limited, and examples include 2-mercaptosuccinic acid, 2,3-dimercaptosuccinic acid, (S)-2-mercaptoglutaric acid, (S)-4-amino-6-mercaptohexanoic acid, 5-mercaptosalicylic acid, 2,4-diaminobenzoic acid, 2,4-pyridinedicarboxylic acid, homocysteine, carbocisteine, aspartic acid, glutamic acid, and the like.

Fabrication method of Solvent-Dispersible Particle

Next, a description will be made of a fabrication method of the solvent-dispersible particle as described above.

The fabrication method includes [1] a first step of obtaining the multi-component alloy particle by a liquid phase synthesis method, [2] a second step of forming a shell (temporarily coat) which covers the surface of the multi-component alloy particle, and obtaining a core shell particle (coated particle), [3] a third step of causing the atom arrangement in the multi-component alloy particle to be ordered by subjecting the core-shell particle to a heat treatment, and [4] a fourth step of simultaneously performing, with respect to the core-shell particle, removal of the shell and bonding of the surface modifiers with the surface of the multi-component alloy particle in the same liquid phase.

Hereinafter, each step will be subsequently described.

[1] First, the multi-component alloy particle is fabricated with the use of the liquid phase synthesis method. The method of fabricating the particle is not particularly limited, and a known method, such as a reverse micelle method, a polyol reduction method, a thermal decomposition method, or the like, can be employed.

[2] Next, the shell is formed so as to cover the surface of the multi-component alloy particle. By forming this shell, it is possible to prevent fusion between the particles when the multi-component alloy particle is subjected to the heat treatment in the second step which will be described later. In addition, since this shell protects the multi-component alloy particle from the heat treatment and is removed in a step which will be described later, this shell has functions as a heat-resistant coat and a temporarily coat.

Although the method of forming the shell is not particularly limited, a known method disclosed in Non-Patent Document 1 (Q. Yan et. al., Adv. Mater. 2006, 18, 2569-2573) or Non-Patent Document 2(D. C. Lee et al., Appl. Phys. Chem. B2006, 110, 11160-11166) can be used. Particularly, when the reverse micelle method is used as the method of fabricating the particle, it is possible to form the shell while synthesizing the particle with the use of the reverse micelle if the method disclosed in Non-Patent Document 1 is applied. Therefore, it is possible to simplify the process of fabricating the solvent-dispersible particle. A description will be made of this method.

First, a non-polar solvent, such as isooctane or the like, is prepared as a solvent, and a nonionic surfactant, such as polyethylene glycol, is prepared as a surfactant. Then, they are mixed to prepare a compound liquid.

Subsequently, an aqueous solution of at least one kind of metallic salt selected from the group of elements A is added to this compound liquid to obtain a reverse micelle solution. In addition, the above compound liquid is separately prepared, and an aqueous solution of at least one kind of metallic salt selected from the group of elements B is added to this compound liquid to prepare the reverse micelle solution.

A value W_{O} (=[water (mol)/[surfactant (mol)]) used as an index of the size of the reverse micelle is correlated with the particle diameter of the multi-component alloy particle which can be obtained as a result of the reaction, and the particle diameter can be controlled by changing W_{O}. In the present invention, W_{O} is preferably 1 to 5.

Then, the reverse micelle solutions are mixed together, and a small amount (about 1 to 2% of the amount of the solvent) of alcohol is added to prepare a reaction solution. If a reductant, such as hydrazine or the like, is added to the reaction solution, and the resultant is stirred for about three hours, multi-component alloy nanocrystal is generated in the reverse micelle (first step).

Thereafter, by adding a raw material for the shell, such as tetraethyl orthosilicate or the like, to the reaction solution, the shell is formed in the reverse micelle so as to cover the multi-component alloy particle, and the core-shell particle is obtained (step 2).

After the completion of the reaction, the reaction solution is sufficiently rinsed with ethanol or the like and then is subjected to a solid-liquid separation process by a known method, such as centrifugal separation. With this process, it is possible to collect the core-shell particle in which the multi-component alloy particle is covered with a shell of metal oxide.

In addition, the constituent material of the shell is determined depending on the raw material added to the reaction solution. When silicon alkoxide is used, for example, a shell of SiO₂ is formed. Examples of raw materials for generating such metal oxides include corresponding metal halide, carboxylate, metal amide, and the like in addition to the corresponding metal alkoxide. Moreover, the examples of the raw material for generating apatites include calcium hydrate, calcium nitrate, and the like and phosphoric acid.

By using such a raw material, it is possible to obtain the shell constituted by oxide, such as SiO₂, TiO₂, Al₂O₃, MgO, ZrO₂, CeO₂, ZnO, and apatites, such as hydroxyapatite and fluoroapatite. Since oxide has a high chemical stability and is difficult to malform or be degraded and reacted with the multi-component alloy particle by the heat treatment under a high temperature, oxide is preferable as a composition material. Particularly, since the method of coating SiO₂ is simple, and SiO₂ can be dissolved in an alkali solution, SiO₂ is preferable as a shell. On the other hand, since apatites, particularly hydroxyapatite can be dissolved in a relatively weak acid solution, when the shell is removed in the step which will be described later, it is possible to easily perform an operation in a short time.

Since the shell which has a fusing temperature higher than the temperature for ordering the multi-component alloy particle, and the ability to be decomposed (dissolved) in acid or alkali is preferable, it is preferable from this viewpoint to appropriately select the raw material of the shell.

When metal oxide is used as the shell, it is preferable to use a metal which has a larger ionization potential than that of Fe as the metal oxide. Thus, when the shell is removed in the liquid phase process in the step which will be described later, it is possible to reliably remove the shell without affecting the multi-component alloy particle which has a small ionization potential.

The average thickness of such a shell is preferably about 1 to 50 nm and more preferably about 5 to 20 nm. By setting the thickness of the shell within the above range, the shell becomes a dividing wall with a necessary and sufficient thickness between the multi-component alloy particles in the second step which will be described later. Therefore, it is possible to reliably prevent fusion between the particles.

[3] Next, the obtained core-shell particle is subjected to the heat treatment. With such an operation, the atom arrangement in the multi-component alloy particle is ordered, and the particle with an ordered structure is obtained (third step).

Here, the heat treatment for the core-shell particles is preferably performed in the state in which inorganic salt particles and the core-shell particles are mixed. Thus, it is possible to prevent the core-shell particles from burning on the wall surface of the container or the like.

Although the conditions of the heat treatment are not particularly limited, the conditions are set so as to be about 0.5 to 12 hours at 550 to 700° C., for example. The heat treatment is preferably performed under an inert atmosphere or a reductive atmosphere, and more preferably under a reductive atmosphere.

The examples of the inorganic salts include sodium chloride, potassium chloride, calcium chloride, and the like, for example. These inorganic salts have relatively high water solubility and can be purchased at a low price. In addition, since these inorganic salts can be removed simply by rinsing with water when removed, they are useful.

In addition, the particles of the inorganic salts to be used are preferably the particles which have been finely ground in advance by a ball mill, a mortar, or the like. Accordingly it is possible to cause the particles of the inorganic salts to fill the gaps between the core-shell particles without any gap remaining and thereby to more reliably prevent burning of the core-shell particle.

Although the average particle diameter of the inorganic salt is not particularly limited, the average particle diameter is preferably about 0.5 to 5 times, and more preferably about 0.7 to 3 times, the average particle diameter of the multi-component alloy particle.

After the heat treatment, by rinsing the reactant several times with a rinsing liquid, such as water, it is possible to obtain the core-shell particle having the multi-component alloy particle in which the crystal structure is transited to have an ordered structure.

If the particles are annealed as described above, the atom arrangement in the multi-component alloy particle is ordered, and the particle has ferromagnetism.

[4] Next, the core-shell particle, which has been subjected to the heat treatment, is made to be in contact with the reaction solution. With such an operation, the shell and the surface modifiers are displaced.

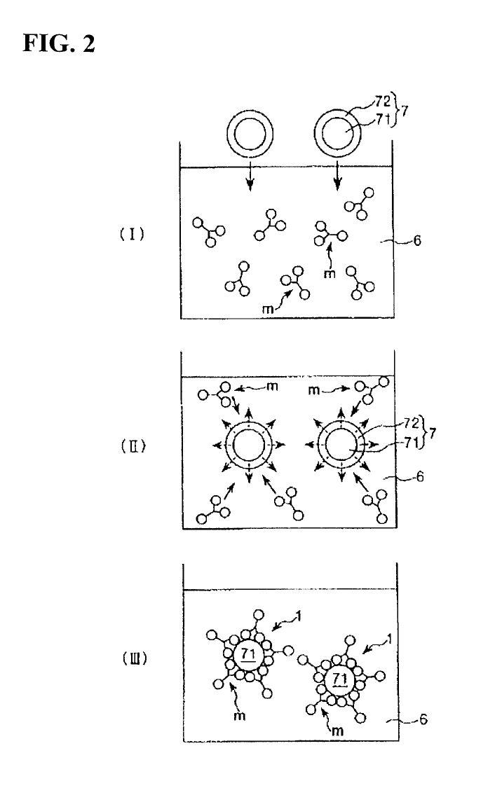

FIG. 2 is a diagram schematically illustrating the state in which a core-shell particle 7 is made to be in contact with a reaction solution 6 retained in a container. The core-shell particle 7 shown in FIG. 2 includes a multi-component alloy particle 71 and a shell 72 which covers the surface thereof.

A reaction solution 6 shown in FIG. 2(I) is a liquid which contains the above-mentioned surface modifiers m and can dissolve the shell 72. When the core-shell particle 7 is made to be in contact with such a reaction solution 6, the shell 72 is dissolved (see FIG. 2(II)). When the shell 72 is dissolved, the multi-component alloy particle 71 is exposed in a bare state. The surface modifiers m in the reaction solution 6 are immediately combined with this exposure surface by interaction. The bonding at this time is caused by an interaction such as a covalent bonding, an ionic bonding, a coordinate bonding, or the like as described above, the bonding strength is relatively strong as compared with electrostatic interaction, the intermolecular force (van der Waals force) or the like, and the bonding is performed for a short time. Accordingly, bonding of the surface modifiers m is performed at the same time as the exposure of the multi-component alloy particle 71, and the solvent-dispersible particle 1 in which the surface of the multi-component alloy particle 71 is covered with the surface modifiers m as shown in FIG. 2(III) is obtained (fourth step).

By simultaneously performing the removal of the shell 72 and bonding of the surface modifiers m within one reaction solution (the same liquid phase) 6 as described above, it is possible to prevent the aggregation between the multi-component alloy particles 71 due to the magnetic attraction force thereof after the shell 72 is dissolved and thereby to secure the dispersiblity of the multi-component alloy particle 71.

In other words, the multi-component alloy particle 71 with an ordered structure easily moves in a liquid due to its large magnetic attraction force (magnetic characteristic), and the aggregation of the multi-component alloy particle 71 starts at the same time when the shell 72 is dissolved. According to the present invention, however, the surface modifiers m are dissolved and dispersed around the multi-component alloy particle 71. Therefore, the surface modifiers m are combined with the surface of the multi-component alloy particle 71 immediately after the shell 72 is dissolved. Thus, a sufficient physical distance is secured between the multi-component alloy particles 71. As a result, it is possible to prevent the aggregation of the multi-component alloy particle 71.

When there is a time difference between the removal of the shell and bonding of the surface modifiers, the aggregation of the particles starts at the same time as the removal of the shell. Once the aggregation starts, it is difficult to recover the separation state again even if an external force is added to the aggregated substance.

In addition, the same is true when the removal of the shell and bonding of the surface modifiers are subsequently performed in different liquid phases. When bonding of the surface modifiers is performed in one liquid phase from among the two liquid phases after the removal of the shell was performed in the other liquid phase, it takes a certain time for the particles to move between the liquid phases. Therefore, the aggregation of the particles is inevitable in the same manner as in the case where there is a time difference.

If the multi-component alloy particles are aggregated in this manner, the surface modifiers are combined so as to cover the aggregate. However, such an aggregate has a small dispersibility and is not suitable for applications as described above.

The reaction solution as described above is not particularly limited as long as the reaction solution can contain the surface modifiers and dissolve the shell. However, an acid solution or an alkali solution with the surface modifiers added thereto is preferably used, for example. Since an acid solution or an alkali solution reliably dissolves the above-mentioned metal oxide or apatites and has a small influence on the multi-component alloy particle, an acid solution or an alkali solution is preferable as a reaction solution.

Although the acid solution is not particularly limited, examples include hydrochloric acid, nitric acid, sulfuric acid, phosphoric acid, and the like. On the other hand, although the alkali solution is not particularly limited, examples include aqueous ammonia, aqueous sodium hydroxide solution, and the like.

Although the concentration of the surface modifiers in the reaction solution is not particularly limited, the concentration is preferably about 2 to 20% by mass, and more preferably about 5 to 10% by mass.

In addition, the ratio between the core-shell particles and the reaction solution is preferably set such that the ratio between the multi-component alloy particle and the surface modifiers becomes 1:10 to 1:100 in terms of mass ratio.

The temperature of the reaction solution with which the surface modifiers are made to be in contact is preferably lower than the decomposition temperature (lower than 70° C., for example) of the surface modifiers. The temperature of the reaction solution is controlled with the use of a hot plate or the like. By immersing the core-shell particle in the reaction solution placed on the hot plate and stirring the liquid, it is possible to effectively and easily perform this step. In addition, by applying ultrasonic waves or vibrations when the liquid is stirred, it is possible to solve the aggregation of the particles accompanying the salting-out effect.

In addition, the contact time of the reaction solution is determined depending on the concentration of the reaction solution and is not particularly limited. However, the contact time is preferably about 5 to 200 hours and more preferably about 10 to 100 hours.

The surface modifiers used in the present invention are preferably dissolved in the above-mentioned reaction solution. Since each molecule of the surface modifiers is uniformly dispersed entirely in the reaction solution, it is possible to dramatically enhance the contact probability between the bare particles after the shells are removed and the molecules of the surface modifiers in this step. As a result, it is possible to more reliably prevent the aggregation of the particles.

After making the core-shell particles come into contact with the reaction solution, a solid-liquid separation process, such as centrifugal separation or the like, is performed on the reaction solution, if necessary, to remove the supernatant solution. With such an operation, it is possible to remove the dissolved matter of the shells and collect the solvent-dispersible particles.

In order to completely remove the shell which has remained without being dissolved, it is also applicable to rinse again with a diluted acid solution or alkali solution. Thereafter, the collected solvent-dispersible particle is added to a polar solvent, such as water, and dispersed. When the polar solvent is water, it is possible to remove impurities in the dispersion by performing a dialysis process several times on this dispersion. On the other hand, when the polar solvent is a solvent other than water, it is possible to remove the impurities by performing a solid-liquid separation process, such as a centrifugal separation or the like. In addition, since the particle has a large magnetization, it is also possible to remove the impurities with the use of magnetic separation.

According to the above-mentioned fabrication method of the solvent-dispersible particle, the removal of the shell and bonding of the surface modifiers are simultaneously performed within one reaction solution (the same liquid phase). Therefore, the surface modifiers can be combined with the surface of the multi-component alloy particle immediately after the shell is removed. Thus, sufficient physical distance can be secured to an extent where the multi-component alloy particle is not aggregated.

Since the surface of the above-mentioned solvent-dispersible particle of the present invention is covered with the surface modifiers of a high density while the multi-component alloy particle has ferromagnetism, the aggregation of the particles can be prevented even when the solvent-dispersible particles are dispersed in a polar solvent (particularly, water). Accordingly, the dispersion (the dispersion of the present invention) which is obtained by dispersing the solvent-dispersible particles of the present invention in the polar solvent is a dispersion in which the solvent-dispersible particles having ferromagnetism are uniformly dispersed. Even if such a dispersion is administered in blood, for example, the dispersion has an affinity for blood without separating therefrom. Accordingly, the dispersion can behave in the same manner as blood in the body and minimize adverse effects on the living body. Thus, the dispersion of the present invention can be applied to biochemistry or the medical field with the use of the characteristic of the dispersion containing ferromagnetic particles.

The examples of the application for the solvent-dispersible particle and the dispersion include a contrast agent to be used in magnetic resonance imaging (MRI), magnetic beads to be used in a magnetic hyperthermia treatment using heat generation of the particles by application of an alternating magnetic field, a carrier for a drug delivery system for administrating a drug into the body in a state where the drug is carried on the surface of the particle, and the like. Since solvent-dispersible particles are dispersed in a polar solvent, such as water, and ferromagnetism of the particles is used for any of these purposes of usage, the solvent-dispersible particle obtained in the present invention can be preferably used.

Although the description was made of the embodiment of the solvent-dispersible particle, the fabrication method thereof, and the dispersion according to the present invention, the present invention is not limited thereto.

When the multi-component alloy particle contains three kinds of metal components, for example, the surface modifiers may include three kinds of functional groups, which respectively interact with the three kinds of metal components, and a functional group having affinity for the polar solvent.

In addition, it is also applicable that something other than that described above is added to the solvent-dispersible particle and the dispersion of the present invention.

### EMBODIMENTS

Hereinafter, specific embodiments of the present invention will be described.

Fabrication and Evaluation of Solvent-Dispersible Particles

### Embodiment 1

<1> Fabrication of FePt/SiO₂ Core-Shell Particles

Into 60 ml of isooctane (manufactured by Wako Pure Chemical Industries, Ltd.), 8.528 g (=0.0125 mol) of nonionic surfactant polyethylene glycol hexadecyl ether (manufactured by Aldrich) is mixed, and the mixture is divided into two. Into one of the two mixtures, 41.5 mg (=0.10 mmol) of K₂PtCl₄ (manufactured by Wako Pure Chemical Industries, Ltd.) and water are added to prepare a platinum salt reverse micelle solution. Into the other of the two mixtures, 29 mg (=0.106 mmol) of FeCl₃.6H₂O (manufactured by KANTO CHEMICAL CO., INC.) and water are added to prepare an iron salt reverse micelle solution. W_{O} is set to be 5. Thereafter, when the two reverse micelle solutions and 700 μl of hexanol are mixed and stirred for a while, and 0.4 ml (=8 mmol) of hydrazine monohydrate (manufactured by Wako Pure Chemical Industries, Ltd.) is then added, the color of the reaction solution is turned to black from transparent yellow. After the reaction solution is stirred for 3 hours, 60 μl (=0.27 mmol) of tetraethylorthosilicate (TEOS, manufactured by TOKYO CHEMICAL INDUSTRY CO., LTD.) is added, and the resultant is stirred by a stirrer for 60 hours. The product is rinsed with ethanol and acetone and then dispersed in ethanol. With such operations, FePt/SiO₂ core-shell particles dispersed in ethanol are obtained.

<2> Ordering of FePt/SiO₂ Core-Shell Particles by Heat Treatment

FePt/SiO₂ core-shell particles are dispersed in ethanol, 2 g of NaCl having been ground by a mortar is added to the obtained dispersion, and the solvent is then volatilized by an evaporator. The mixture is annealed under a foaming gas (mixed gas of N₂: 96.5% by volume and H₂: 3.5% by volume) atmosphere at 600° C. for 4 hours. After being annealed, the mixture is rinsed several times with water and acetone, and FePt/SiO₂ core-shell particles with an ordered structure are obtained.

An evaluation is made by X-ray diffraction (XRD) measurement for the crystalline structure of the obtained particles, by transmission electron microscope (TEM) observation for the particle diameters, and by a superconducting quantum interference device (SQUID) measurement for magnetic characteristics. The average particle size of the obtained particle is 15 nm.

<3> Fabrication of FePt Alloy Particle Dispersed Water by Exfoliation of SiO₂ Shells and Introduction of Surface Modifiers

First, 0.75 g (concentration of 0.5 M) of 2-mercaptosuccinic acid (MSA, manufactured by Wako Pure Chemical Industries, Ltd.) and 3.6 g (concentration of 2 M) of tetramethyl ammonium hydroxide pentahydrate (TMAOH.5H₂O, manufactured by TOKYO CHEMICAL INDUSTRY CO., LTD.) are dissolved in 10 ml of water to prepare a reaction solution. In addition, the number of carbon atoms between the functional group X (COOH) and the functional group Y (RSH) is 1 or 2 in 2-mercaptosuccinic acid.

Then, 5 mg of the above FePt/SiO₂ core-shell particles after the heat treatment is immersed in this reaction solution, and the thus obtained reaction solution is left on a hot plate at 70° C. for 2 days. With such an operation, the removal of the SiO₂ shells and the introduction of the surface modifiers are simultaneously preformed in the same reaction solution. In addition, since the particles are aggregated by a salting-out effect, dispersing is appropriately made for the reaction solution by ultrasonication.

After the reaction, the reaction solution is subjected to a centrifugal separation process, and the supernatant solution is removed. In order to remove remaining SiO₂, the reaction solution is rinsed with 1 M aqueous NaOH solution. Thereafter, the reaction solution is rinsed with water again, water is added thereto, and thereby the obtained particles are satisfactorily dispersed in water. Thereafter, a dialysis process is performed five times, the resultant is finally dispersed in water, and dispersed water in which 2-mercaptosuccinic acid modified FePt alloy particles (solvent-dispersible particle) are dispersed in water is obtained.

<4> Evaluation of Solvent-Dispersible Particle

As for the obtained solvent-dispersible particle, evaluation is made by XRD measurement for the crystalline structure, by TEM observation for the shapes of the particles, and by SQUID measurement for magnetic characteristics, respectively.

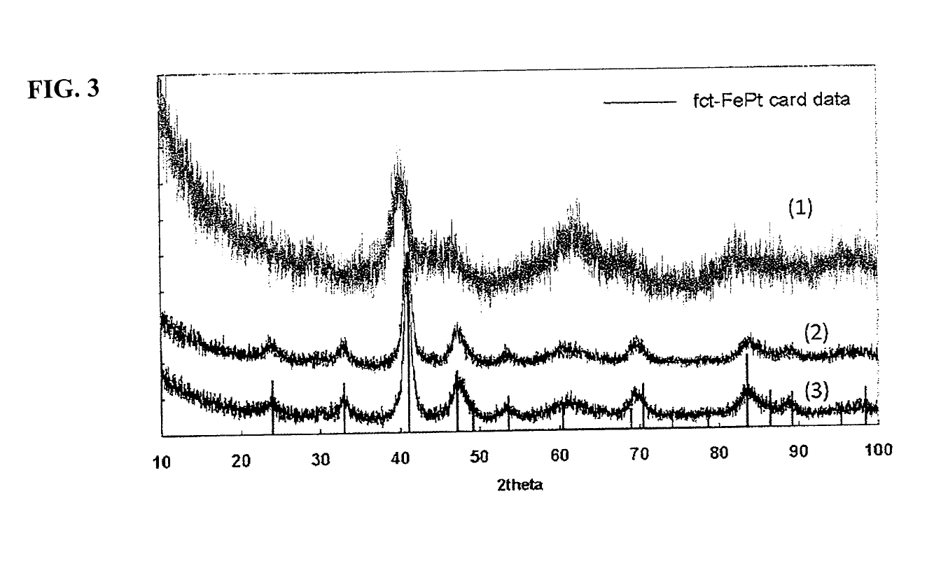

FIG. 3 shows the result of the XRD. In FIG. 3, (1) is an XRD pattern of the FePt/SiO₂ core-shell particle before the heat treatment, (2) is an XRD pattern of the FePt/SiO₂ core-shell particle after the heat treatment, and (3) is an XRD pattern of the 2-mercaptosuccinic acid modified FePt alloy particle (solvent-dispersible particle) after the process of being dispersed in water (the removal of SiO₂ and the bonding of the surface modifiers). It can be confirmed from the comparison between the XRD pattern of (1) and the XRD pattern of (2) that the crystalline structure has been shifted to the ordered phase by the heat treatment. A characteristic peak is observed in the XRD pattern of (2), and the arrangement of this peak coincides well with card data of FePt alloy with an ordered structure (fct structure). In addition, it can be confirmed from the comparison between the XRD pattern of (2) and the XRD pattern of (3) that the crystalline structure of the particle dispersed in water has not changed from the crystalline structure after the heat treatment and the introduction of the surface modifiers does not affect the crystalline structure of the FePt alloy particle.

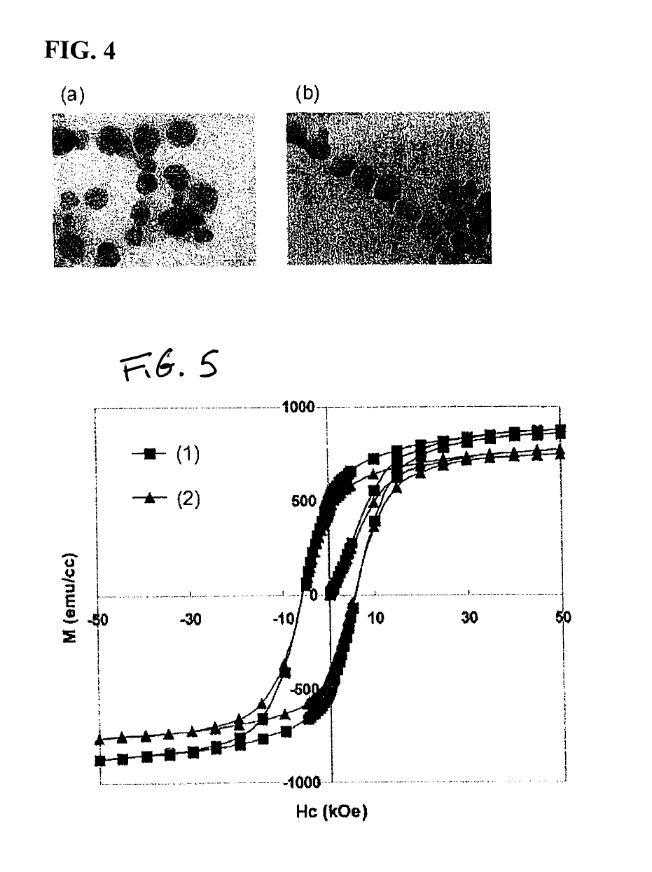

FIG. 4 shows the results of TEM observation. In FIG. 4, (a) is an observation image of the FePt/SiO₂ core-shell particle after the heat treatment, and (b) is an observation image of the 2-mercaptosuccinic acid modified FePt alloy particle after the process of being dispersed in water. It can be confirmed from (a) that the FePt alloy particle in the deep color area is covered with the SiO₂ shell in the light color area. It can be considered from (b) that SiO₂ could be removed since the shell in the light color area is not observed around the FePt alloy particle. It is considered that the particles are aligned in long strings due to the magnetic interaction. However, since gaps are observed between particles, it is considered that the particles are aligned in long strings because the surface modifiers are combined with the particle surface to prevent aggregation of the particles.

FIG. 5 shows H-M curves obtained by SQUID measurement. In FIG. 5, (1) is an H-M curve of the FePt/SiO₂ core-shell particle after the heat treatment, and (2) is an H-M curve of the 2-mercaptosuccinic acid modified FePt alloy particle after the process of being dispersed in water. The H-M curves of (1) and (2) substantially overlap with each other. As for the coercivity, 5.6 kOe is observed for (1), and 5.5 kOe is observed for (2). As for the residual magnetization, 498 emu/cc is observed for (1), and 427 emu/cc is observed for (2). The magnetic characteristics are not very different between (1) and (2). It can be confirmed from the above results that the solvent-dispersible particle obtained in Embodiment 1 is constituted by a ferromagnetic body.

When the solvent-dispersible particles thus obtained are dispersed in water and left for a day, no generation of precipitates and the like is observed. Thereafter, when the solvent-dispersible particles are left for 7 days, no change is observed.

### Embodiment 2

The operations until the fabrication of the FePt/SiO₂ core-shell particles after the heat treatment are performed in the same manner as in Embodiment 1.

Then, 0.6 g (concentration of 0.5 M) of L-cysteine (Cys, manufactured by TOKYO CHEMICAL INDUSTRY CO., LTD.) and 3.6 g (concentration of 2 M) of tetramethyl ammonium hydroxide pentahydrate are dissolved in 10 ml of water to prepare a reaction solution. In addition, the number of carbon atoms between the functional group X (RNH₂) and the functional group Y (RSH) is 2 mL-cysteine.

Then, 5 mg of the above FePt/SiO₂ core-shell particles after the heat treatment are immersed in this reaction solution, and the obtained reaction solution is left on a hot plate at 70° C. for 2 days. The subsequent operations are performed in the same manner as in Embodiment 1, and the dispersed water in which the L-cysteine modified FePt alloy particles (solvent-dispersible particles) are dispersed in water is obtained.

As for the obtained solvent-dispersible particle, evaluation is made by XRD measurement for the crystalline structure. The particle structure is an ordered phase, and no change is observed before or after the process of dispersing the particles in water. It can be confirmed by TEM observation that the SiO₂ shells have been removed. The magnetic characteristics are evaluated by SQUID measurement. The coercivity is 5.5 kOe, the residual magnetization is 431 emu/cc, and the magnetic characteristics are not very different before and after processing with water.

When the solvent-dispersible particles thus obtained are dispersed in water and left for a day, no generation of precipitates and the like is observed. Thereafter, the solvent-dispersible particles are left for 7 days, but no change is observed.

### Embodiment 3

The operations until the fabrication of the FePt/SiO₂ core-shell particles after the heat treatment are performed in the same manner as in Embodiment 1.

Then, 0.73 g (concentration of 0.5 M) of L-glutamic acid (manufactured by TOKYO CHEMICAL INDUSTRY CO., LTD.) and 3.6 g (concentration of 2 M) of tetramethyl ammonium hydroxide pentahydrate are dissolved in 10 ml of water to prepare a reaction solution. In addition, the number of carbon atoms between the functional group X (RNH₂) and the functional group Y (COOH) is 1 mL-glutamic acid.

Then, 5 mg of the above FePt/SiO₂ core-shell particles after the heat treatment are immersed in this reaction solution, and the obtained reaction solution is left on a hot plate at 75° C. for a day. The subsequent operations are performed in the same manner as in Embodiment 1, and the dispersed water in which the L-glutamic acid modified FePt alloy particles (solvent-dispersible particles) are dispersed in water is obtained.

As for the obtained solvent-dispersible particle, evaluation is made by XRD measurement for the crystalline structure. The particle structure is an ordered phase, and no change is observed before or after the process of dispersing the particles in water. It can be confirmed by TEM observation that the SiO₂ shells have been removed.

Although the solvent-dispersible particles thus obtained are dispersed in water and left for a day, no generation of precipitates and the like is observed. Thereafter, the solvent-dispersible particles are left for 7 days, but no change is observed.

### Embodiment 4

A reaction solution is prepared in the same manner as in Embodiment 1 except that 2-mercaptosuccinic acid is replaced with (S)-4-amino-6-mercaptohexanoic acid, and dispersed water in which (S)-4-amino-6-mercaptohexanoic acid modified FePt alloy particles (solvent-dispersible particles) are dispersed in water is obtained. In addition, the number of carbon atoms between the functional group X (RNH₂) and the functional group Y (COOH) is 3 in (S)-4-amino-6-mercaptohexanoic acid.

As for the obtained solvent-dispersible particle, evaluation is made by XRD measurement for the crystalline structure. The particle structure is an ordered phase, and no change is observed before and after the process of dispersing the particles in water. It can be confirmed by TEM observation that the SiO₂ shells have been removed.

When the solvent-dispersible particles thus obtained are dispersed in water and left for a day, no generation of precipitates and the like is observed. Thereafter, the solvent-dispersible particles are left for 3 days, but no change is observed. However, a small amount of precipitates is observed after the solvent-dispersible particles have been left for 7 days.

### Embodiment 5

A reaction solution is prepared in the same manner as in Embodiment 1 except that 2-mercaptosuccinic acid is replaced with 5-mercaptosalicylic acid, and dispersed water in which 5-mercaptosalicylic acid modified FePt alloy particles (solvent-dispersible particles) are dispersed in water is obtained. In addition, the number of carbon atoms between the functional group X (ROH) and the functional group Y (RSH) is 4 in 5-mercaptosalicylic acid.

As for the obtained solvent-dispersible particle, evaluation is made by XRD measurement for the crystalline structure. The particle structure is an ordered phase, and no change is observed before and after the process of dispersing the particles in water. It can be confirmed by TEM observation that the SiO₂ shells have been removed.

Although the solvent-dispersible particles thus obtained are dispersed in water and left for a day, no generation of precipitates and the like is observed. However, a small amount of precipitates is observed after the solvent-dispersible particles have been left for 3 days.

### Embodiment 6

Dispersed water in which 2-mercaptosuccinic acid modified CoPd alloy particles (solvent-dispersible particles) are dispersed in water is obtained in the same manner as in Embodiment 1 except that CoPd alloy particles are used instead of FePt alloy particles.

As for the obtained solvent-dispersible particle, evaluation is made by XRD measurement for the crystalline structure. The particle structure is an ordered phase, and no change is observed before and after the process of dispersing the particles in water. It can be confirmed by TEM observation that the SiO₂ shells have been removed.

Although the solvent-dispersible particles thus obtained are dispersed in water and left for a day, no generation of precipitates and the like is observed. Thereafter, the solvent-dispersible particles are left for 7 days, but no change is observed.

### Embodiment 7

The core-shell particles are obtained in the same manner as in Embodiment 1 except that the compound liquid of phosphate aqueous solution and calcium hydroxide suspension is used instead of tetraethyl orthosilicate. In addition, the obtained core-shell particle is an FePt/hydroxyapatite (HAp) core-shell particle in which a shell of HAp is formed so as to cover the FePt alloy particle.

Thereafter, the heat treatment, the exfoliation of the shells, and the introduction of the surface modifiers are sequentially performed in the same manner as in Embodiment 1 except that hydrochloric acid solution (concentration of 1% by weight) is used instead of tetramethyl ammonium hydroxide pentahydrate when the exfoliation of the shells and the introduction of the surface modifiers are performed.

As for the obtained solvent-dispersible particle, evaluation is made by XRD measurement for the crystalline structure. The particle structure is an ordered phase, and no change is observed before and after the process of dispersing the particles in water. It can be confirmed by TEM observation that the HAp shells have been removed.

The solvent-dispersible particles thus obtained are dispersed in water and left for a day, but no generation of precipitates and the like is observed. Thereafter, the solvent-dispersible particles are left for 7 days, but no change is observed.

### Comparative Example 1

The operations until the fabrication of the FePt/SiO₂ core-shell particles after the heat treatment are performed in the same manner as in Embodiment 1.

Then, 5 g (concentration of 3.8 M) of 6-aminohexanoic acid (AHA, manufactured by Wako Pure Chemical Industries, Ltd.) and 1.6 g (concentration of 4 M) of sodium hydroxide (NaOH, manufactured by TOKYO CHEMICAL INDUSTRY CO., LTD.) are dissolved in 10 ml of water to prepare a reaction solution.

Then, 5 mg of the above FePt/SiO₂ core-shell particles after the heat treatment are immersed in this reaction solution, and the obtained reaction solution is left on a hot plate at 70° C. for 2 days. The subsequent operations are performed in the same manner as in Embodiment 1, and the dispersed water in which the 6-aminohexanoic acid modified FePt alloy particles are dispersed in water is obtained.

As for the obtained alloy particle, evaluation is made by XRD measurement for the crystalline structure. The particle structure is an ordered phase, and no change is observed before and after the process of dispersing the particles in water. It can be confirmed by TEM observation that the SiO₂ shells have been removed. The magnetic characteristics are evaluated by SQUID measurement, and no change is observed in the coercivity and the residual magnetization before pr after processing with water.

The concentrations of the dispersion obtained in Embodiment 1 and the dispersion obtained in Comparative Example 1 are measured. The concentration of the dispersion in Embodiment 1 is 5.6×10¹⁰/μl while the concentration of the dispersion in Comparative Example 1 is 9.6×10⁹/μl. It has been clarified from this result that the concentration of the dispersion in Embodiment 1 is higher, and furthermore, aggregation does not occur even at high concentrations and the alloy particle has high dispersibility in the dispersion in Embodiment 1.

When the dispersion obtained in Comparative Example 1 is left, generation of precipitates is observed in about a day.

The reason that the results as described above are obtained can be considered as follows. That is, only two kinds from among the three kinds of functional groups for bonding are contained in the surface modifiers used in Comparative Example 1 while the surface modifiers used in Embodiment 1 has the functional group X combined with Fe, the functional group Y combined with Pt, and the functional group Z having affinity for the polar solvent, and the functional groups X and Y are firmly combined with the FePt alloy particle. Therefore, the surface modifiers establish a weak bonding with respect to the FePt alloy particle because the bonding with the particle surface is formed only by one kind of functional group, or the dispersibility of the FePt alloy particle in the solvent is insufficient because the functional group having high affinity for the solvent does not exist on the side of the solvent even if the bonding with the particle surface is formed by two kinds of functional groups.

### Comparative Example 2

A reaction solution is prepared in the same manner as in Embodiment 1 except that 6-aminohexanoic acid is replaced with 4-aminobenzoic acid, and dispersed water in which 4-aminobenzoic acid modified FePt alloy particles are dispersed in water is obtained. In addition, 4-aminobenzoic acid has an amino group and a carboxyl group as the functional groups.

As for the obtained alloy particle, evaluation is made by XRD measurement for the crystalline structure. The particle structure is an ordered phase, and no change is observed before or after the process of dispersing the particles in water. It can be confirmed by TEM observation that the SiO₂ shells have been removed.

The obtained alloy particles are dispersed in water and left for a day, and the generation of precipitates is observed.

### Comparative Example 3

The operations until the fabrication of the FePt/SiO₂ core-shell particles after the heat treatment are performed in the same manner as in Embodiment 1.

Then, in order to remove the SiO₂ shells, 5 mg of the above FePt/SiO₂ core-shell particles are immersed in 10 ml of tetramethylammonium hydroxide aqueous solution (2 M), and the reaction solution is left on a hot plate at 70° C. for 2 days. After the reaction, the reaction solution is subjected to a centrifugal separation process, and the supernatant solution is removed. In order to remove remaining SiO₂, the reaction solution is rinsed with 1 M aqueous NaOH solution, water is then added thereto again to perform the centrifugal separation process at 4000 rpm at 10 minutes, and thereby the FePt alloy particles are collected. These particles are dried for 12 hours at ambient temperature.

Then, 10 ml of water and 0.75 g of 2-mercaptosuccinic acid are mixed to prepare a reaction solution, and the reaction solution is stirred for 2 days. After being stirred, the reaction solution is rinsed with water again, water is added thereto, and the particles which have been obtained by irradiating ultrasonic waves for 10 minutes are dispersed in water.

After the FePt alloy particles thus obtained are dispersed in water and left overnight, all the particles are precipitated.

As for the obtained FePt alloy particle, evaluation is made by XRD measurement for the crystalline structure. The particle structure is an ordered phase, and it can be confirmed by TEM observation that the SiO₂ shells have been removed. On the other hand, the aggregation between the particles can be observed in TEM observation image.

### Comparative Example 4

The dispersion of the particles in water is attempted by dispersing the FePt alloy particles in an organic solvent with the use of the method in Patent Document 1 and then performing the displacement of the surface modifiers.

The operations until the fabrication of the FePt/SiO₂ core-shell particles after the heat treatment are performed in the same manner as in Embodiment 1.

Then, 0.03 g of the above FePt/SiO₂ core-shell particles, 3 g (4 M) of aqueous sodium hydroxide solution, 5 g of chloroform, and 0.5 g of cetyl trimethyl ammonium bromide (CTAB) are mixed and stirred for 24 hours.

After the stirring, 15 g of chloroform is added to the reaction solution, centrifugal separation is performed on the reaction solution at 4000 rpm for 10 minutes, and a chloroform phase is extracted. The yield of the particles collected in the chloroform phase is 12%, and most of the particles precipitate.

Thereafter, 0.75 g of 2-mercaptosuccinic acid and 10 ml of water are added to the chloroform dispersion of the FePt alloy particles obtained by the above method and stirred for 24 hours. After the stirring, the reaction solution is left until the reaction solution is separated into two phases, and the water phase is extracted by sucking the upper phase with a pipette. However, substantially no particles exist in the water phase.

### CONCLUSION

It has been clarified from the above results that the solvent-dispersible particles obtained in the respective embodiments have high dispersibility in the polar solvent, such as water.

On the hand, it has been clarified that the particles obtained in the respective Comparative Examples are aggregated in a short time and precipitates occur even if the particles are dispersed in the polar solvent, such as water.

Description of Reference Numerals and Signs
1: Solvent-Dispersible Particle
10: Multi-Component Alloy Particle with Ordered Structure
11: Multi-Component Alloy Particle with Disordered Structure
6: Reaction solution
7: Core-Shell Particle
71: Multi-Component Alloy Particle
72: Shell
a: Element Belonging to Group of Elements A
b: Element Belonging to Group of Elements B
m: Surface Modifiers
s: Bonding
X, Y, Z: Functional Group

Obviously, numerous modifications and variations of the present invention are possible in light of the above teachings. It is therefore to be understood that within the scope of the appended claims, the invention may be practiced otherwise than as specifically described herein.

1. A multi-component alloy particle, comprising:
at least two metal components; and
at least one surface modifier, contacting the metal components,
wherein, in the multi-component alloy particle, atoms of the metal components are arranged in an ordered manner, and the multi-component alloy particle is ferromagnetic and disperses in a solvent,
wherein the surface modifier comprises, within its one molecule:
at least one functional group X interacting with at least one, but not all, of the at least two metal components;
at least one functional group Y interacting with the metal components with which X does not interact; and
at least one functional group Z having affinity for a polar solvent.

2. The particle of claim 1, wherein the at least two metal components comprise:
(A) at least one element A selected from the group consisting of transitional metal elements belonging to the 4th period of a long format periodic table, excluding Cu; and
(B) at least one element B selected from the group consisting of transitional metal elements belonging to the platinum group and the 11th group of the long format periodic table.

3. The particle of claim 2, wherein:
the at least one element A comprises Fe or Co; and
the at least one element B comprises Pt or Pd.

4. The particle of claim 2, wherein:
the at least one functional group X interacts with the at least one element A; and
the at least one functional group Y interacts with the at least one element B.

5. The particle of claim 1, wherein:
the at least one functional group X interacts with the at least one element A by covalent bonding, ionic bonding, or coordinate bonding; and
the at least one functional group Y interacts with at least one element B by covalent bonding, ionic bonding, or coordinate bonding.

6. The particle of claim 1, wherein:
the at least one functional group X is a functional group which can become a hard base; and
the at least one functional group Y is a functional group which can become a soft base.

7. The particle of claim 1, wherein the at least one functional group Z is polar.

8. The particle of claim 1, wherein the surface modifier has 1 to 4 carbon atoms between the functional group X and the functional group Y.

9. The particle of claim 1, wherein the surface modifier comprises a carboxyl group on at least one of its ends.

10. The particle of claim 1, having an average diameter of 1 to 30 nm.

11. The particle of claim 1, having a coercivity of greater than or equal to 1 kOe.

12. The particle of claim 1, wherein the at least one functional group X is selected from the group consisting of a primary amino group, a secondary amino group, a carboxyl group, a deprotonated carboxyl group, a hydroxy group, a deprotonated hydroxy group, an ether group, a phosphine oxide group, a phosphonate group, a phosphinate group, a phosphate group, a sulfonate group, and a β-diketone group.

13. The particle of claim 1, wherein the at least one functional group Y is selected from the group consisting of an aromatic amino group, a pyridyl group, an amide group, a mercapto group, a deprotonated mercapto group, a sulfide group, a phosphine group, a phosphite ester group, a thiophene group, an ethene group, an alkyl group, a cyano group, a thiocyano group, sulfoxide group, and a sulfonic group.

14. The particle of claim 1, wherein the at least one functional group Z is selected from the group consisting of —COO—, —NH3+, —SO3—, —PO32—, —R3N+, —O—, —O—, and an ethylene glycol group.

15. The particle of claim 1, wherein the surface modifier is at least one selected from the group consisting of 2-mercaptosuccinic acid, 2,3-dimercaptosuccinic acid, (S)-2-mercaptoglutaric acid, (S)-4-amino-6-mercaptohexanoic acid, 5-mercaptosalicylic acid, 2,4-diaminobenzoic acid, 2,4-pyridinedicarboxylic acid, homocysteine, carbocisteine, aspartic acid, and glutamic acid.

16. The particle of claim 1, wherein the ordered manner of atoms of the metal components is a face-centered tetragonal (fct) structure in which the element A and the element B are alternately laminated.

17. A method of manufacturing the particle of claim 1, the method comprising:
(A) forming a temporary coat on the multi-component alloy particle which covers the multi-component alloy particle, to obtain a coated particle;
(B) annealing the coated particle to thereby cause a crystal structure of the particle to become ordered and have ferromagnetism;
(C) removing the temporary coat in a liquid phase, to expose a surface of the multi-component alloy particle; and
(D) bonding the surface modifiers to the surface of the particle,
wherein the removing (C) and the bonding (D) are performed simultaneously, in a same liquid phase.

18. A dispersion obtained by dispersing the particle of claim 1 in a polar solvent.

19. The dispersion of claim 13, wherein the polar solvent is water.
